(19) United States
(12) Patent Application Publication
(10) Pub. No.: US 2014/0200972 A1
(43) Pub. Date: Jul. 17, 2014

(54) SYSTEMS AND METHODS FOR AD REVENUE SHARING IN E-MAILS

(71) Applicant: Leo Jeremias, Los Angeles, CA (US)

(72) Inventor: Leo Jeremias, Los Angeles, CA (US)

(21) Appl. No.: 14/158,537

(22) Filed: Jan. 17, 2014

Related U.S. Application Data
(60) Provisional application No. 61/753,888, filed on Jan. 17, 2013.

(51) Int. Cl. G06Q 30/02

(52) U.S. Cl. CPC G06Q 30/0274
USPC 705/14.7

(57) ABSTRACT

In a system where e-mail content is monetized based on content, a computer method includes scanning an e-mail for targeted keywords associated with advertiser bids for advertisement and detecting the keywords using an e-mail server, determining at least one advertisement associated with at least one of the detected keyword having a highest advertiser bid, creating an advertisement in the e-mail based on the at least one advertisement, sending the e-mail to a recipient, receiving a payment corresponding to a click on the advertisement, and sending at least part of the payment to a user which sent the e-mail, wherein the created advertisement includes a uniform resource locator, and wherein the payment is split between an operator of the e-mail server and the user which sent the e-mail.

### CROSS-REFERENCE TO RELATED APPLICATIONS

This application claims the benefit of and priority to U.S. Provisional Application No. 61/753,888, filed Jan. 17, 2013, hereby incorporated by reference in its entirety.

### BACKGROUND OF THE INVENTION

The present invention relates generally to the field of electronic advertising. Advertisements may be presented to a user of a computer system. The advertisements may include text and/or images and a link to an advertiser's webpage. When a user clicks on the advertisement they may be directed to the advertiser's webpage. The content generator may receive advertisement revenue for placing an ad with their content. Revenue may be paid per click on the advertisement. Ads can be presented to users in an e-mail environment.

### SUMMARY OF THE INVENTION

One embodiment of the invention relates to a system where e-mail content is monetized based on content and a computer method including scanning an e-mail for targeted keywords associated with advertiser bids for advertisement and detecting the keywords using an e-mail server, determining at least one advertisement associated with at least one of the detected keyword having a highest advertiser bid, creating an advertisement in the e-mail based on the at least one advertisement, sending the e-mail to a recipient, receiving a payment corresponding to a click on the advertisement, and sending at least part of the payment to a user which sent the e-mail, wherein the created advertisement includes a uniform resource locator, and wherein the payment is split between an operator of the e-mail server and the user which sent the e-mail.

### BRIEF DESCRIPTION OF THE DRAWINGS

FIG. 1 illustrates an e-mail received by a recipient including advertisements from a user according to an exemplary embodiment of a revenue sharing system.

FIG. 2 illustrates a block diagram of an exemplary embodiment of an e-mail advertisement system according to the present invention.

FIG. 3 illustrates a block diagram of an e-mail server according to an exemplary embodiment.

FIG. 4 illustrates a flow chart of a method of placing an advertisement in an e-mail and receiving payment for an ad click according to an exemplary embodiment.

### DETAILED DESCRIPTION

The systems and methods according to the present invention allow everyday e-mail users to earn money from everyday work and actions. The system may scan an email for keywords in a user's e-mail that the user is sending to recipients. Advertisers willing to pay for that keyword may place bids that are maintained in a database. Extensible Markup Language (XML) feeds may be used to place advertisements in the e-mail using an e-mail server after the user has sent the e-mail. The advertisements may be placed in the e-mail while the e-mail is in transit from a user to a recipient. The party running the e-mail server would then get paid for each time an e-mail recipient clicks on an advertisement. In turn, a user may be offered a portion of the revenue (e.g., revenue sharing) as a percentage of the advertiser payment in compensation for including advertisements in their e-mails. Thus, the present invention creates the ability to earn money from sending emails to friends and coworkers if the recipient clicks on an advertisement in the email.

Generally, the present invention provides for a system which allows for the presentation of advertisements to users in an e-mail client. The advertisements may be sent to users from a sender who has enabled advertisements to be sent via e-mail to other users. The system may be implemented using an e-mail server, a program local on the e-mail sender's computing device (e.g., personal computer, mobile phone, tablet, or other computing device, an e-mail client plug in, or other hardware or software implementation. The system may present one or more types of advertisements (ads). For example, the system may present an advertisement in an e-mail recipient's e-mail as an advertisement on the right hand side of the recipient's e-mail client. Continuing the example, advertisements may be displayed to a recipient when the recipient mouses over a keyword (e.g. an in-text advertisement). The in-text advertisement may include of two or three lines of text which are displayed to the recipient. In other embodiments, the advertisements may be displayed to the sender of the e-mail or other user of the system.

In some embodiments, a user of the system selects advertisements which are sent to the e-mail's recipient. The system according to the invention may present advisement options to the user before the user sends the e-mail. In some embodiments, the system scans the e-mail for keywords. For example, the e-mail server implementing the system scans the user's email. The system provides a user with advertisement options. The options shown to the user may be optimized to show the user the highest paying advertisements (e.g., for a particular keyword the system displays two or three advertisement options which would pay the user the highest amount of money to be included in the sent e-mail). The options may appear when a user hovers a mouse or other pointing device over a detected keyword. Detected keywords may be highlighted or their color changed in order to indicate an advertisement may be enabled for the keyword. In some embodiments, the advertisement options may be displayed on the right hand side (e.g., as banner ads) or in another location (e.g., left, top, or bottom of the page). This functionality may be implemented via an e-mail server, local computer program, e-mail client plug-in, web browser plug-in, or other hardware and/or software implementation.

In some embodiments, the system determines the highest paying advertisement for a keyword by querying a database accessible by the e-mail server (e.g., stored on the e-mail server or located remote to but communicably connected to the e-mail server). The database may be populated by advertisers seeking to participate in revenue sharing by allowing users to include their advertisements in e-mails sent to recipients. In some embodiments, a user may determine whether or not to include advertisements in sent e-mails and indicate that decision to the system by using a monetize button.

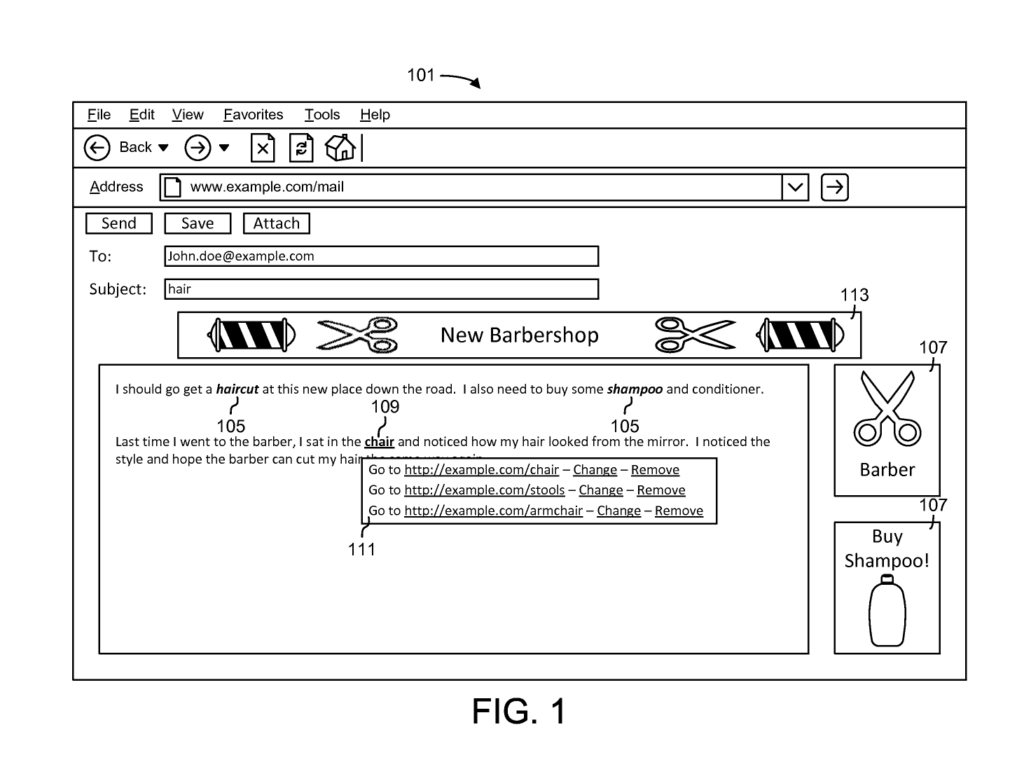

Referring now to FIG. 1, an e-mail 101 received by a recipient including advertisements from a user is illustrated according to one embodiment of the system. The e-mail 101 includes in text ads 109 and sideline ads 107. In text ad 109 may be a colored word to indicate that the word has an associated ad. In other embodiments, the keyword forming the in text ad 109 is highlighted to indicate the presence of an ad. In further embodiments, the keyword which forms the in text ad 109 is not altered and appears as normal text. When a user (e.g., e-mail recipient) mouses over the in-text ad keyword, an ad is displayed to the user with lines of text 111. In some embodiments, 3 lines of text are displayed with each line corresponding to a different advertisement. In other embodiments, two, one, or any other number of lines and/or ads may be shown to a recipient when they mouse over the in-text ad 109 keyword. For example, the word chair may be an in-text ad 109. When the recipient mouses over the word chair, three lines 111 of advertisements may be shown to the user. For example, line one may read “www.chairfinder.com,” line two may read “the best place on the internet for chairs,” and line three may read “mention ‘email for 20% discount.’” In some embodiments, two or more lines 111 may form a single advertisement. In some embodiments, lines 111 of in-text ad 109 may be uniform resource locators (URLs), hyperlinks, executable code, or another programmed device which directs a recipient to an advertiser's website, third party website, or other location on the internet, an intranet, or locally on the recipient's computing device.

An e-mail to a recipient according to the present invention may also include side advertisements 107. Side advertisements may be located on the right, left, bottom, and/or top side of an e-mail to a recipient. In some embodiments, side advertisements 107 are associated with keywords 105 detected in the user's e-mail. The keywords may be detected when the e-mail is scanned by an e-mail server or otherwise detected as described herein. A side advertisement 107 may be linked to a keyword 105. In some embodiments, keyword 105 associated with a side ad 107 is highlighted in a first color. The side ad 107 is also highlighted in the first color. In some embodiments, keyword 105 may be in font that is the first color. Side advertisement 107 may include a border that is the first color. A second side ad 107 and keyword 105 pair may be highlighted in a second color. Advantageously, this allows a recipient to determine more information about the side ad 107 by looking at the associated keyword 105. This may provide context for the side ad 107. Additionally, the highlighted keyword 105 may serve as a trigger prompting a recipient to look to the side and see an associated side ad 107.

Side ad 107 may be any combination of text and/or images. In some embodiments, side ad 107 may include audio and/or video components. In further embodiments, side ad 107 may serve as a link to the advertiser's website or another web page. Side ad 107 may include or be uniform resource locators (URLs), hyperlinks, executable code, or another programmed device which directs a recipient to an advertiser's website, third party website, or other location on the internet, an intranet, or locally on the recipient's computing device. In some embodiments, a plurality of side ads 107 may be displayed for a single keyword 105.

For example, the word “Haircut” was detected when the e-mail was scanned by the system. The system may determine that the word “haircut” is a keyword with associated advertisements (e.g., by querying a database of detriment placements). The system then ads side ad 107 to the e-mail 101 sent to the recipient. For example, the advertisement may be for a barber. The keyword 105 “haircut” can be yellow and the corresponding side ad 107 on the right for barbers can be yellow Continuing the example, the keyword 105 “shampoos” show a side ad 107 or ads for shampoos. The word “shampoos can be blue,” with the side ad 107 for the shampoo in the color blue as well (e.g., with a blue border, blue background, blue text, a combination of the preceding, or other blue component).

In some embodiments, the e-mail 101 received by the recipient includes one or more banner ads 113. Banner ads 113 may be located above the e-mail 101, at the top of the browser window, below the e-mail 101, at the bottom of the browser window, in corresponding locations to the left or right, and/or in other locations visible to the e-mail recipient. Banner ads 113 may be related to a keyword detected in the user's e-mail. In some embodiments, the associated keyword 105 is highlighted in the same color as the banner ad. In other embodiments, the banner ad and 113 and associated keyword 105 are not linked in a way visible to the e-mail 101 recipient.

In some embodiments, the e-mail sent using the system of the present invention is limited to including one in-text advertisement 109 and three side advertisements 107. Advantageously, this may prevent a recipient from being overwhelmed by many advertisements and may increase the likelihood of the recipient clicking on one or more of the advertisements. Additionally, with a limited number of advertisements, the readability of the e-mail may not be compromised. In other embodiments, the number of ads is not limited or may be limited in different amounts.

In some embodiments, the advertisements displayed to the e-mail recipient are chosen according to an optimization algorithm which scans the e-mail and detects keywords for which advertisers have indicated they are willing to pay to place an advertisement. The algorithm may also query a database of advertisers for the particular keyword and determine which advertiser is willing to pay the greatest amount per click on the advertisements by e-mail recipients. The system then may place the highest paying ads into the e-mail to the recipient using the techniques described above.

In some embodiments, the ad with the highest bid is placed in the e-mail as an in-text ad and the remaining ads with the highest paying bid are placed in the e-mail as other types of ads (e.g., banner ads or side ads). In other embodiments, the highest paying ad may be placed in the e-mail as a different type of ad. In further embodiments, the highest paying advertiser bid may specify where the ad is to be placed in an e-mail.

In some embodiments, a user sending an e-mail to a recipient is presented with a user interface (UI) prior to sending the e-mail. In one embodiment, the user interface is a plug-in, locally running program, web application, or other type of display to the user on the user's computing device. The user may allow the user to select which ads are displayed to the e-mail recipient. The user interface may also provide a preview of the e-mail to be sent to the recipient including the advertisements that will be displayed. The user interface may include a button labeled “monetize.” The monetize button may toggle whether or not the e-mails sent from the user to recipients include advertisements. Advantageously, the user may determine when to include advertisements and when not to include advertisements. For example, a user sending a sensitive e-mail, work e-mail, or other e-mail in which ads may not be appropriate may toggle advertisements off using the monetize button. A user may toggle the advertisements on by pressing the monetize button again. Thus a user may select when to send e-mails with advertisements included and when to send e-mails without advertisements.

The “monetize” button may be added to an existing e-mail client, be a browser toolbar, desktop application, other program, or otherwise allow a user to toggle advertisements on and off. In further embodiments, the user interface may include an identifier of and/or be associated with a user account. The user interface may be a webpage or series of webpages that a user can access which are linked to an account for the user. The “monetize” button may be included in the user account webpages. In some embodiments, the user account provides the ability for users to turn monetization on and off as they see fit (e.g., with the “monetize” button. The user account may also allow user to monitor the traffic, the number of times recipients click on advertisements, the average cost per click, their total revenue, and/or additional information related to advertisements sent by the user and the revenue they generate. In some embodiments, the user account webpages may be hosted by an e-mail server of the system of the present invention. In other embodiments, a computing device hosting the user account webpages or other computing device managing the user account is in communication with the e-mail server of the present invention. This allows for a user to see information (e.g., number of clicks, cost per click, traffic, etc.) generated by or tracked by the e-mail server or another computing device of the present invention. This communication also allows for the user to toggle ads on or off using the “monetize” button or other feature or component of the UI.

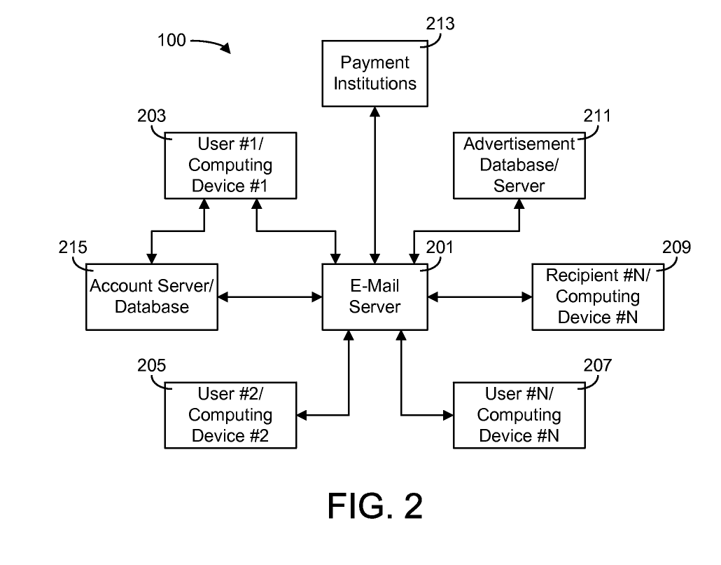

FIG. 2 illustrates a block diagram of an exemplary embodiment of an e-mail advertisement system 100 according to the present invention.

Multiple users (User #1 203, User #2 205, User #N 207, etc.) and/or email recipients 209 send and receive e-mails through an e-mail server 201 (e.g., Yahoo Mail, Gmail, Hotmail, etc.). The e-mail server 201 can communicate to each user through a network such as the Internet. The e-mail server 201 is also connected to an advertisement database or server 211. The advertisement database 211 includes advertisements to be placed into e-mails sent from a first user (e.g., user #1 203). The e-mail server 201 is also connected through the network to a payment institution or payment processor 213. In some embodiments, one or more of the advertisement database 211 and the payment institution or payment processor 213 may be included in e-mail server 201. For example, the advertisement database 211 may be stored in memory included in e-mail server 201.

In some embodiments, advertisement database or server 211 includes a listing of advertisements cross referenced or otherwise linked to an associated keyword. Included with the advertisement keyword pair may be information such as the identity of the advertiser, an amount the advertiser is willing to pay per click on the advertisement, advertiser preferences such as which type of ads are used, advertiser payment information, or other information regarding the ad to be placed.

In some embodiments, payment institutions 213 may include an entity which transfers payments according to the number of advertisement clicks. The payment institutions may receive payment information from e-mail server 201 and pay the operator of e-mail server 201. The operator of e-mail server 201 may then forward part of the payment or otherwise provide payment to a user. In some embodiments, payment institution 213 may pay a user directly based on information received from e-mail server 201.

The e-mail server 201 may receive an e-mail from a first user to be sent to a recipient 209 and/or other user (e.g., user #2 205). In some embodiments, the e-mail is typed into a form which can be received or read by e-mail server 201. In some embodiments, e-mail server 201 may be one or more servers or other computing devices.

The e-mail server 201 may determine whether the sender (e.g., user #1 203) wishes to include advertisements in the e-mail. This may be done by receiving an input from a UI as described above. E-mail server 201 may receive an input from a user corresponding to toggling on and off advertisements via the “monetize” button. The e-mail server 201 may store this determination in memory and associate it with a particular user profile or user account. In this way, a user can opt in or opt out of sending e-mails with advertisements. In some embodiments, e-mail server 201 may communicate with an account server or database 215. An input controlling the toggling of ads may be received by e-mail server 201 from account server or database 215.

The account server or database 215 may collect or receive information regarding a user's activity (e.g., the number of times a recipient clicks on ads placed in the user's e-mails to that recipient) from e-mail server 201. E-mail server 201 may collect or receive account preferences such as whether to include advertisements in e-mails, whether to include advertisements in a particular e-mail, number of advertisements to include in an e-mail, or other information from account server or database 215. In some embodiments, a user (e.g., user #1 203) may communicate directly with account server or database 215. For example, account server or database 215 may serve a user with a webpage or webpages containing a UI or other user account components, elements, and/or features. In other embodiments, account server or database 215 may be included in e-mail server 201. For example, an account database 215 (e.g., including user information and/or preferences) may be stored locally in e-mail server 201. In some embodiments, account server or database 215 may include additional user information such as identification information, payment information such as an account number at which the user will receive payment, or other information about the user.

If advertisements are enabled, the e-mail server 201 scans the e-mail for keywords, matches the keywords with keywords/target words of advertisements in the advertisement database or server 211, selects the highest-paying advertisements for the keywords, and inserts the advertisements into the e-mail. The advertisements can be text advertisements placed in-line in the email and/or banner advertisements off to the side of the main text of the e-mail as previously described with reference to FIG. 1.

In certain arrangements, the recipient of the e-mail can opt out of receiving advertisements in e-mails as well. The e-mail server 201 determines whether the recipient wishes to receive advertisements in the email. In some embodiments, e-mail server 201 may store information related to particular recipients 209 and/or users (e.g., 203, 205, 207) pertaining to e-mail receipt preferences. If the recipient 209 and/or user receiving the e-mail has opted out, the e-mail server 201 does not include advertisements in the e-mail.

If the sender agrees to include the advertisements in his or her sent e-mails, and the receiving user clicks or views one of the advertisements, the owner of the e-mail server 201 and the sending user (e.g., user #1 203) share revenue received from an advertiser based on the click.

Multiple users (e.g., user #1 203, user #2 205, user #N 207) may send and receive e-mails using e-mail server 201. A plurality of recipients N 209 may receive e-mail from e-mail server 201 as well. In some embodiments, e-mail server 201 does not distinguish between users and recipients (e.g., a user can be a sender or recipient of an e-mail from e-mail server 201). Advantageously, a recipient of an e-mail from e-mail server 201 is not required to be a user of e-mail server 201 in some embodiments. Users and/or recipients may send and/or receive e-mail from e-mail server 201 or perform other functions described herein using a computing device connected to e-mail server 201, account server or database 215, or another component of the system. For example, a user may be connected wired or wirelessly and may use one or more of a computer, cell phone, tablet, mobile computing device, or other computing device.

The above system also can function through other networked message delivery systems such as SMS, MMS, instant messaging, etc.

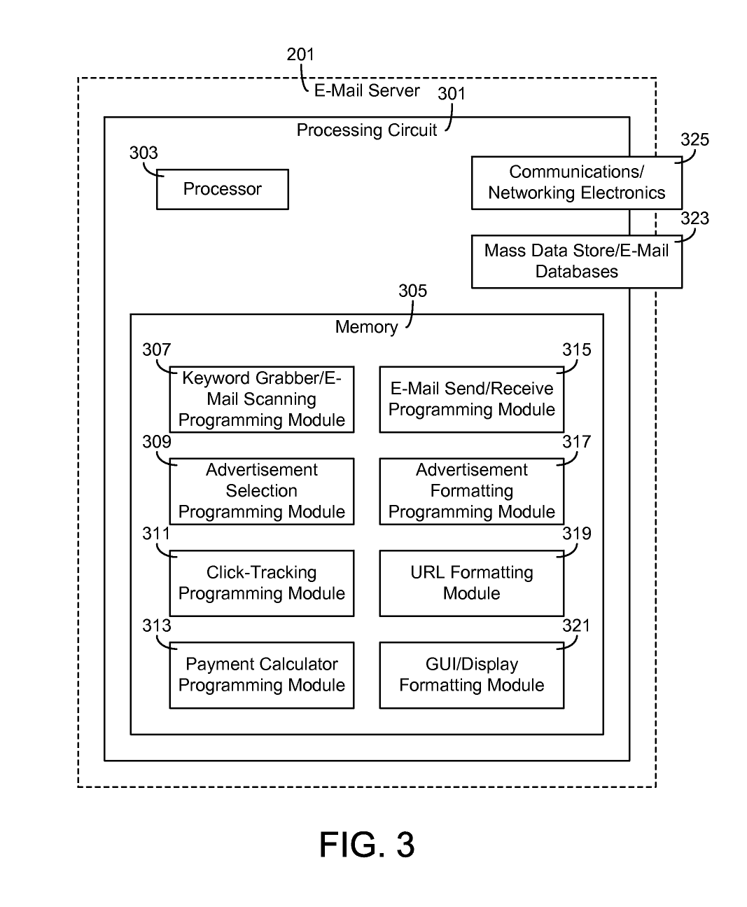

Referring now to FIG. 3, a block diagram of e-mail server 201 is illustrated according to an exemplary embodiment. E-mail server 201 includes a processing circuit 301. The processing circuit includes a processor 303 and memory 305. Memory includes programming modules, that when executed by the processor, control the operation of the e-mail server 201. The processing circuit 301 including the modules in memory 305 may perform the functions described herein with respect to the system. The processing circuit 301 includes and/or communicates with communications and networking electronics 325 (e.g., Ethernet, wireless transceiver, WiFi module, etc.). Further, the processing circuit includes and/or communicates with a mass data store and e- mail databases 323. The mass data store and e-mail databases 323 include user account information and storage space for the sent/received e-mails. The mass data store and e-mail databases 323 may be physically located outside of the e-mail server 201 but in communication with the e-mail server 201 through the communications and networking electronics 325. In some embodiments, memory 305 may be located remote from e-mail server 201 but be in communication with e-mail server 201. Memory 305 may be volatile or non-volatile and include storage of data beyond the modules discussed herein.

As briefly mentioned above, the memory 305 may include various programming modules, that when executed by the processor 303, control the operation of the e-mail server 201. The memory modules may include a keyword grabber/e-mail scanning programming module 307. Keyword grabber/e-mail scanning programming module 307 may include instructions for scanning e-mails to be sent by e-mail server 201 for keywords contained in the text of the e-mail. The keywords may be identified by querying advertisement database or server 211 (e.g., through use of communications and networking electronics 325).

The memory modules may include an advertisement selection programming module 309. Advertisement selection programming module 309 may include instructions for matching identified keywords with keywords of various advertisements that are available for being sent with the e-mail. For example, advertisement selection programming module 309 may contain an algorithm for determine the highest paying advertisement associated with a detected keyword. The advertisement selection programming module 309 may determine that such an advertisement is the one which should be included. In some embodiments, advertisement selection programming module 309 may include an algorithm which determines the combination of advertisements which will generate the greatest amount of ad revenue taking into considerations such as the CPC, advertiser preferences, user preferences, e-mail content, or other factors.

The memory modules may include an advertisement formatting programming module 317. Advertisement formatting programming module 317 may include instructions for formatting matched advertisements for sending with the e-mail. The advertisements can be formatted to appear in-line in the text of the e-mail as in-text ads 109, surrounding at least a portion of the text of the e-mail in the form of a side ads 107, and/or as banner advertisements 113.

The memory modules may include a URL formatting module 319. URL formatting module 319 may format tracking URLs for the advertisements such that e-mail server 201 can track whether a user or recipient clicked on an advertisement sent with the e-mail. E-mail server 201 may also track which of multiple ads in an e-mail where clicked and/or how many times a particular ad was clicked.

The memory modules may include an e-mail send/receive programming modules 315. E-mail send/receive programming modules 315 may include instructions for sending and receiving e-mail messages to/from users of the e-mail server and/or other recipients. For example, e-mail send/receive programming modules 315 may handle e-mail addresses and/or routing functions, provide information regarding the same, or otherwise perform functions related to sending, receiving, and/or routing e-mails.

The memory modules may include a click-tracking programming module 311. Click-tracking programming module 311 may include instructions for tracking whether a recipient of an email containing advertisements clicks on the advertisement. In some embodiments, click-tracking programming module 311 may be used in tandem with URL formatting module 319 to track the number of times an advertisement is clicked.

The memory modules may include a graphical user interface or display formatting module 321. Graphical user interface or display formatting module 321 may include instructions for formatting how the e-mail is displayed to a user. This may include displaying a preview of the e-mail containing ads to a user before the e-mail is sent to a recipient. In some embodiments, graphical user interface or display formatting module 321 may be used to display the “monetize” button to a user and/or handle inputs and/or outputs related to a UI. In further embodiments, graphical user interface or display formatting module 321 may be used to create a UI for user accounts and handle inputs and/or outputs related to the user account.

The memory modules may include a payment calculator programming module 313. Payment calculator programming module 313 may include instructions for calculating a designated payment to users of the e-mail server 201 and how to transfer the payment (e.g., directly to an account at a bank via a bank account number and a routing number, etc.). This may include determining what percentage of revenue from an advertisement is owed to a particular user and what portion is retained by the operator of the e-mail server 201. In some embodiments, payment calculator programming module 313 may be used in conjunction with payment institutions 213 to facilitate payment of a user and/or the operator of e-mail server 201. For example, a payment calculator programming module 313 may generate payment instructions which are forwarded to payment institution 213. Payment instructions may include instructions to make a payment, the account number from which the payment is made, the amount of the payment, one or more account numbers to which the payment is made, or other payment information or instructions.

Generally, the system may operate in the following manner according to one embodiment. The system scans the email for targeted keywords that have advertiser bids. The system grabs the keyword with highest CPC (cost per click). The system creates the highest paying bidder link ad with keyword rollover to show the advertiser URL with an explanation of the URL. The system grabs additional high paying keywords and creates ads on right side of the email, one ad per keyword with 2 or 3 lines of ad per keyword. The system creates the email and creates all ads with tracking URLs and sends the email tracking the URL to the e-mail recipient's account. The receiver clicks on an ad and the click is credited to the sender and the value of the click is split between the user sending the e-mail and the provider running the system.

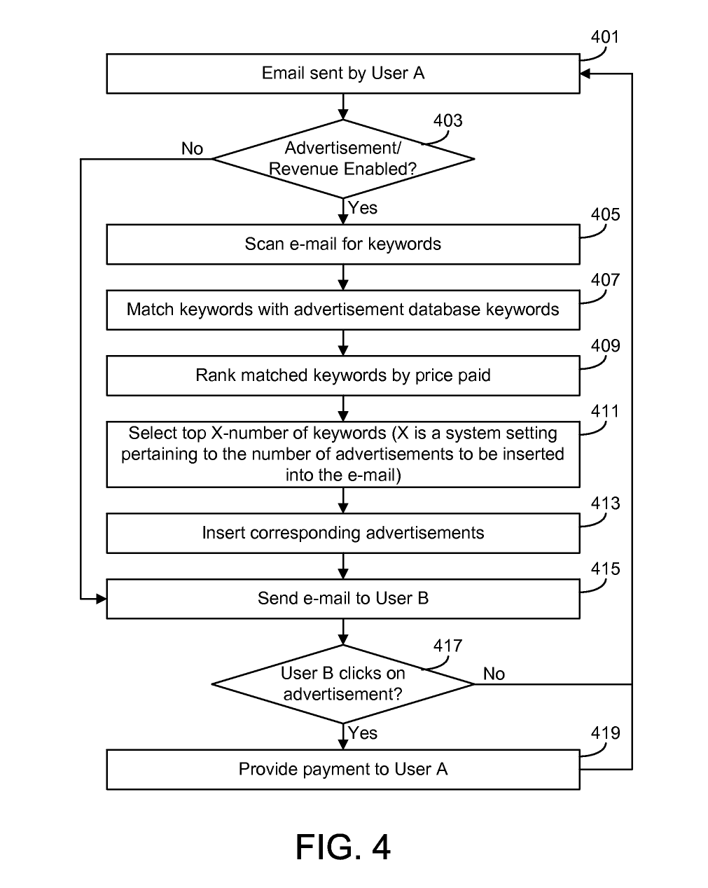

FIG. 4 illustrates a flow chart of a method of placing an advertisement in an e-mail and receiving payment for an ad click according to an exemplary embodiment. In one embodiment, when a user sends an e-mail through the e-mail server, the server performs the following steps. The system receives an e-mail for sending by a sender (shown as user A) and the system analyzes the e-mail to determine the status of the e-mail, the sender's identity, and the recipient's identity (401). This step may include querying an account server or database 215 to determine information about the sender of the e-mail. In some embodiments, information about the recipient of the e-mail such as e-mail address is also determined.

The system determines whether the sender has enabled advertisement insertion and revenue sharing (403). This step may include querying an account server or database 215 to determine what the account settings of the user are in regard to monetization (e.g., if the user has enabled ads in outgoing messages using the “monetize” button).

If the sender has not enabled advertisement insertion, the e-mail is sent to the recipient (415) (shown as user B) without any advertisements being inserted, and the process repeats each time the sender sends an email. In some embodiments, if ads have not been enabled, the e-mail server 201 may skip step (417) and begin the process again by receiving an e-mail.

If advertisement insertion is enabled, the system scans the e-mail for keywords or target words (405). This step may include querying the advertisement database or server 211 to determine what keywords are tied to offers to place an advertisement in the e-mail. The system then matches the identified keywords or target words with advertisements (407). In some embodiments, the e-mail is scanned for all keywords associated with advertisements in the advertisement database or server 211. In other embodiments, the e-mail is scanned and all words are recognized. Then advertisement database or server 211 is queried to determine if any of the words in the e-mail are keywords associated with an advertisement.

The system then ranks the matched advertisements based on a cost paid out by the advertiser (409) for all detected keywords having an associated advertisement in the advertisement database or server 211. The system then selects the top X-number of advertisements corresponding to the X-number highest paying advertisements (411). X may be a system setting pertaining to the number of advertisements to be inserted into the e-mail. In some embodiments, user A can adjust the number of advertisements inserted. In other embodiments, the number X is set by the operator of e-mail server 201. For example, X may be two, allowing only two ads per e-mail. In some embodiments, X may be further subdivided by type of advertisement. For example, the system may allow 2 in-text advertisements, 3 side ads, and one banner ad per e-mail. Other combinations are possible and in some embodiments may be customized by one or more of user A or the operator of e-mail server 201.

The system then inserts the selected advertisements (413). Advertisements can be inserted in-line as text advertisements and/or apart from the text of the e-mail as a banner advertisement or side advertisement. Each advertisement includes a tracking URL allowing the system to identify when an advertisement is clicked on by the recipient (user B).

The system determines if the recipient (user B) clicks on an advertisement (417). In some embodiments, the system determines if an ad has been clicked using tracking URLs, click-tracking programming module 311, and/or URL formatting module 319. If the recipient does not click on an advertisement, no payment is sent, and the process repeats each time an e-mail is sent. If the recipient clicks on an advertisement, a payment amount may calculated by the system and payment provided to the sender (419) (e.g., by transferring funds directly to a bank account on file for the sender). The process repeats for each e-mail sent through the system.

The above discussed e-mail advertising systems and methods do not need to be embedded into an e-mail server. An external module (e.g., plug-in) and/or stand-alone server in communication with the e-mail server can perform one or more of the above functions and methods.

What is claimed is:

1. In a system where e-mail content is monetized, a computer method comprising:
scanning an e-mail for targeted keywords associated with advertiser bids for advertisement and detecting the keywords using an e-mail server;
determining at least one advertisement associated with at least one of the detected keyword having a highest advertiser bid;
creating an advertisement in the e-mail based on the at least one advertisement;
sending the e-mail to a recipient;
receiving a payment corresponding to a click on the advertisement; and
sending at least part of the payment to a user which sent the e-mail,
wherein the created advertisement includes a uniform resource locator, and wherein the payment is split between an operator of the e-mail server and the user which sent the e-mail.

2. The method of claim 1, further comprising:
creating an in-text advertisement in the e-mail for the advertisement with the highest advertiser bid;
determining at least a second advertisement associated with at least one of a second detected keyword having a highest advertiser bid
creating at least one of a side advertisement and banner advertisement based on the second advertisement

3. The method of claim 2, wherein in-text advertisement includes two lines of text which are display to a user when the user mouses over an associated keyword, and wherein the in text-advertisement includes at least one of a uniform resource locator and an explanation of the uniform resource locator.

4. The method of claim 2, wherein in-text advertisement includes three lines of text which are display to a user when the user mouses over an associated keyword, and wherein the in text-advertisement includes at least one of a uniform resource locator and an explanation of the uniform resource locator.

5. The apparatus of claim 1, wherein maximum number of advertisements created is the total of one in-text advertisement and three side advertisements.
